(19) United States
(12) Patent Application Publication
(10) Pub. No.: US 2026/0064154 A1
(43) Pub. Date: Mar. 5, 2026

(54) WEARABLE DEVICE

(71) Applicant: VIVO MOBILE COMMUNICATION CO., LTD., Dongguan (CN)

(72) Inventors: Junhui XIAO, Dongguan (CN); Jiantang LIN, Dongguan (CN)

(21) Appl. No.: 19/381,076

(22) Filed: Nov. 6, 2025

Related U.S. Application Data
(63) Continuation of application No. PCT/CN2024/091168, filed on May 6, 2024.

(30) Foreign Application Priority Data
May 11, 2023 (CN) 202310533496.8

(51) Int. Cl. G06F 1/16

(52) U.S. Cl. CPC G06F 1/163

(57) ABSTRACT

A wearable device is disclosed, including: a wearing portion, where the wearing portion has wearing space; an adjustment component connected to the wearing portion, where the adjustment component includes a first bracket and a gear structure, the first bracket has a rack structure, the rack structure extends in a first direction, and the gear structure meshes with the rack structure; and a functional component, where the functional component is connected to the gear structure, and rotation of the gear structure causes the gear structure to move in the first direction relative to the rack structure, so that the functional component is driven to move in the first direction.

This application is a bypass continuation application of International Application No. PCT/CN2024/091168, filed on May 6, 2024, which claims the benefit of and priority to Chinese Patent Application No. 202310533496.8 filed on May 11, 2023, the contents of both of which being incorporated by reference in their entireties herein.

### TECHNICAL FIELD

This application relates to the field of wearable product technologies and, more specifically, relates to a wearable device.

### BACKGROUND

After a device, such as an AR/VR device (e.g., AR/VR glasses) is worn and fastened, it is difficult to adjust the position of the display or the glasses themselves. This limited range of adjustment reduces user flexibility and makes it harder to meet individual user needs.

### BRIEF SUMMARY

An embodiment of this application provides a wearable device, including:
a wearing portion, where the wearing portion has wearing space;
adjustment component connected to the wearing portion, where adjustment component includes a first bracket and a gear structure, the first bracket has a rack structure, the rack structure extends in a first direction, and gear structure meshes with the rack structure; and
a functional component, where the functional component is connected to the gear structure, and rotation of the gear structure causes the gear structure to move in the first direction relative to the rack structure, so that the functional component is driven to move in first direction.

Additional aspects and advantages of this application will be set forth in part in the following description, and will become apparent in part from the following description, or may be learned from practice of this application.

### BRIEF DESCRIPTION OF DRAWINGS

The foregoing and/or additional aspects and advantages of this application will become apparent and readily understood from the descriptions of embodiments with reference to the following accompanying drawings.

FIG. 1 is a schematic structural diagram of a wearable device according to an embodiment of this application;

FIG. 2 is an exploded structural diagram of a wearable device according to an embodiment of this application;

FIG. 3 is a side view of a wearable device according to an embodiment of this application;

FIG. 4 is a partial side view of a wearable device according to an embodiment of this application;

FIG. 5 is another partial side view of a wearable device according to an embodiment of this application;

FIG. 6 is still another partial side view of a wearable device according to an embodiment of this application;

FIG. 7 is a partial sectional view of a wearable device according to an embodiment of this application;

FIG. 8 is another partial sectional view of a wearable device according to an embodiment of this application;

FIG. 9 is still another partial sectional view of a wearable device according to an embodiment of this application;

FIG. 10 is still another partial sectional view of a wearable device according to an embodiment of this application;

FIG. 11 is still another partial sectional view of a wearable device according to an embodiment of this application;

FIG. 12 is still another partial sectional view of a wearable device according to an embodiment of this application; and

FIG. 13 is a schematic diagram of wearing of a wearable device according to an embodiment of this application.

### REFERENCE NUMERALS

Wearable device 100;
Wearing portion 10; Wearing space 11;
Adjustment component 20; First bracket 21; Rack structure 211; Gear structure 22; Second limiting structure 221; Fourth limiting groove 222; Gear tooth 223; Adjustment rod 23; First limiting structure 231; Guiding recess 232; First knob 24; First limiting groove 241; Third limiting groove 242; First toggling portion 243; Second toggling portion 244; Second knob 25; Second limiting groove 251; First snap ring 26; Second snap ring 27;
Second bracket 31; First cavity 32; First limiting member 33; First guiding portion 331; First flange portion 332; Third bracket 34; Guiding through-hole 341; Sliding slot 342; Self-locking component 35; Self-locking limiting member 351; Connection portion 3551; Notch 3552; First self-locking limiting portion 3553; Second self-locking limiting portion 3554; Second limiting member 36; Second guiding portion 361; Second flange portion 362;
Functional component 40; Housing 41; Mounting hole 411; Accommodating recess 412; Limiting protrusion 413;
Human head 50.

### DETAILED DESCRIPTION

The following describes in detail the embodiments of this application, and the examples of the embodiments are shown in the accompanying drawings. Identical or similar reference numerals represent identical or similar elements or elements having identical or similar functions. Embodiments described below with reference to the accompanying drawings are merely examples, and are intended to explain this application without being construed as limiting this application. All other embodiments obtained by a person of ordinary skill in the art based on the embodiments of this application without creative efforts shall fall within the protection scope of this application.

In the specification and claims of this application, if features of terms “first” and “second” are involved, one or more such features may be explicitly or implicitly included. In the descriptions of this application, unless otherwise specified, “a plurality of” means two or more. In addition, in this specification and the claims, “and/or” indicates at least one of connected objects, and a character “/” generally indicates an “or” relationship between associated objects.

In the description of this application, it should be understood that an orientation or positional relationship indicated by the term “center”, “longitudinal”, “transverse”, “length”, “width”, “thickness”, “upper”, “lower”, “front”, “back”, “left”, “right”, “vertical”, “horizontal”, “top”, “bottom”, “internal”, “external”, “clockwise”, “counterclockwise”, “axial direction”, “radial direction”, “circumferential direction”, or the like (if it is involved) is based on an orientation or positional relationship shown in the accompanying drawings, and is merely for ease of describing this application and simplifying the description, but does not indicate or imply that an apparatus or an element referred to must have a specific orientation or be constructed and operated in a specific orientation, and therefore cannot be understood as a limitation on this application.

In the description of this application, it should be noted that, unless otherwise specified and defined, the terms “mount”, “connection”, and “connected to” (if they are involved) should be comprehended in a broad sense. For example, a connection may be comprehended as a fixed connection, a detachable connection, or an integral connection; or a mechanical connection or an electrical connection; or a direct connection or an indirect connection by using an intermediate medium, or an internal communication between two elements. For a person of ordinary skill in the art, specific meanings of the foregoing terms in this application may be understood based on a specific situation.

This application aims to provide a wearable device, which can at least resolve the following problems in a related technology: it is inconvenient for smart glasses to adjust positions of a screen and the glasses, presenting a small degree of freedom, and consequently, a use requirement of a user cannot be better met.

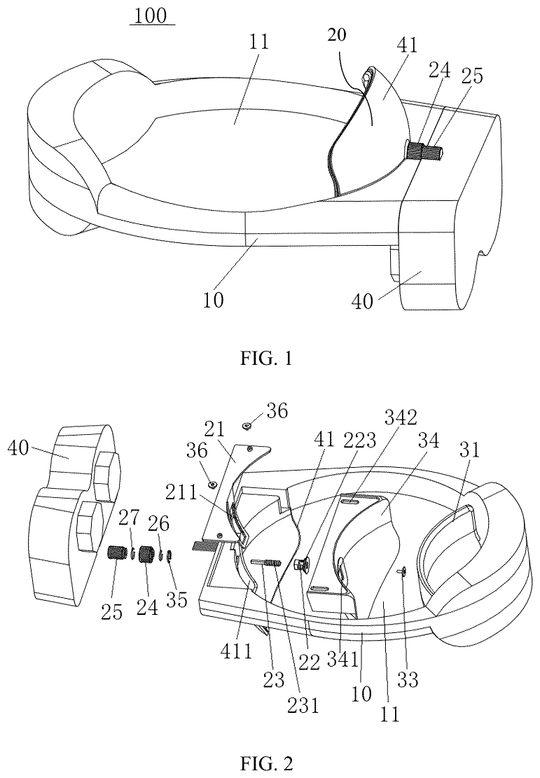

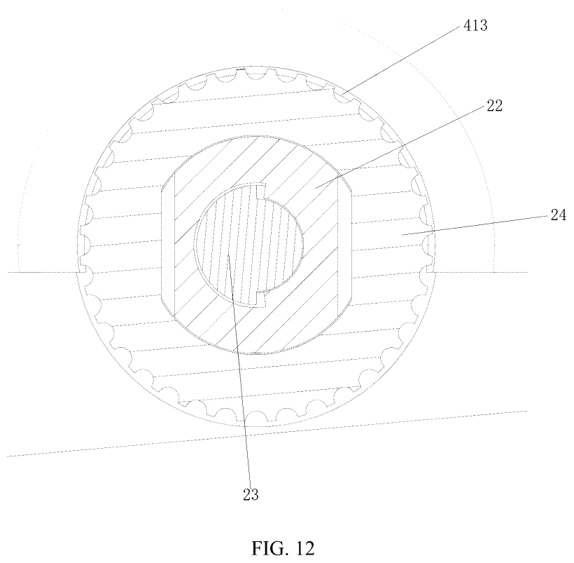

With reference to FIG. 1 to FIG. 13, a wearable device 100 provided in the embodiments of this application is to be described in detail by using specific examples and application scenarios thereof.

As shown in FIG. 1 to FIG. 3, a wearable device 100 according to an embodiment of this application includes a wearing portion 10, an adjustment component 20, and a functional component 40.

Specifically, the wearing portion 10 has wearing space 11, the adjustment component 20 is connected to the wearing portion 10, the adjustment component 20 includes a first bracket 21 and a gear structure 22, the first bracket 21 has a rack structure 211, and the rack structure 211 extends in a first direction. The gear structure 22 meshes with the rack structure 211. The functional component 40 is connected to the gear structure 22, and rotation of the gear structure 22 causes the gear structure 22 to move in the first direction relative to the rack structure 211, so that the functional component 40 is driven to move in the first direction.

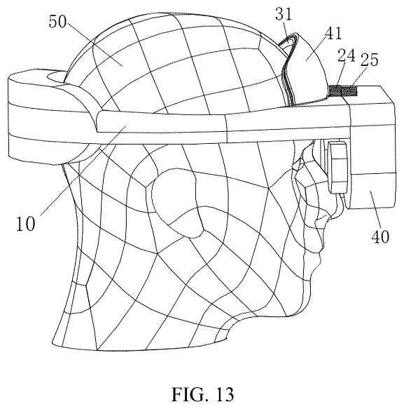

In other words, referring to FIG. 1 to FIG. 3, the wearable device 100 according to this embodiment of this application is mainly composed of the wearing portion 10, the adjustment component 20, and the functional component 40. The wearing portion 10 has the wearing space 11 for a human head 50 to wear, and the wearing portion 10 is worn on the human head 50 (refer to FIG. 13). In a description process of the following embodiment of this application, when the wearing portion 10 is worn, a part that is of the wearing portion 10 and that is approximately located at a forehead position may be understood as a front portion of the wearing portion 10, and a part that is of the wearing portion 10 and that is approximately located at an afterbrain position may be understood as a rear portion of the wearing portion 10.

The adjustment component 20 is connected to the wearing portion 10, and the adjustment component 20 is approximately disposed at the front position of the wearing portion 10. As shown in FIG. 2, the adjustment component 20 is mainly composed of the first bracket 21 and the gear structure 22. The first bracket 21 has the rack structure 211, and the rack structure 211 extends approximately in the first direction. The gear structure 22 meshes with the rack structure 211. The functional component 40 is connected to the gear structure 22, and the functional component 40 has a display screen suitable for viewing by human eyes. After a user wears the wearing portion 10, the user may rotate the gear structure 22 to drive the gear structure 22 to move in the first direction relative to the rack structure 211, so as to drive the functional component 40 to move in the first direction, thereby adjusting a position of the functional component 40 and a position of glasses of the user, ensuring that a position of a screen center of the functional component 40 is consistent with a position of a pupil center of the human eye, meeting a use requirement of the user, and improving use experience of the user. In this application, the gear structure 22 is rotated to adjust the position of the functional component 40, so that a structure is simple, use is facilitated, a degree of freedom is high, and it is convenient for the user to perform free adjustment based on a requirement.

It should be noted that the wearable device 100 in this application may be a device such as an AR (Augmented Reality)/VR (Virtual Reality) device (for example, AR/VR glasses). In the following embodiments of this application, the AR/VR glasses may be used as an example for description.

Therefore, in this embodiment of this application, the adjustment component 20 is disposed on the wearing portion 10, and the functional component 40 is connected to the gear structure 22 by using the first bracket 21 and the gear structure 22 in the adjustment component 20. Through rotation of the gear structure 22, the gear structure 22 is driven to move in the first direction relative to the rack structure 211 in the first bracket 21, so that the functional component 40 moves in the first direction, to adjust the position of the functional component and the position of the glasses of the user, and meet the use requirement of the user. In this application, the gear structure 22 is rotated to adjust the position of the functional component in 40, so that a structure is simple, use is facilitated, a degree of freedom is high, and it is convenient for the user to perform free adjustment based on a requirement.

According to an embodiment of this application, the functional component 40 has a housing 41, the first bracket 21 is located between the wearing portion 10 and the housing 41, a mounting hole 411 is disposed on one side of the housing 41, the gear structure 22 is rotatably disposed in the mounting hole 411, and a gear tooth 223 of the gear structure 22 is located outside the mounting hole 411 to mesh with the rack structure 211. In a case that the gear structure 22 moves in the first direction relative to the rack structure 211, the gear structure 22 drives, by using the housing 41, the functional component 40 to move in the first direction.

In other words, referring to FIG. 1 and FIG. 2, the functional component 40 has the housing 41, and the housing 41 may be integrated with the functional component 40 to form a whole with the functional component 40. The housing 41 may be used as an independent structure as a part of the functional component 40, and is fixedly connected to the functional component 40 or detachably connected in another manner.

The first bracket 21 is disposed between the wearing portion 10 and the housing 41, and the mounting hole 411 is disposed on one side of the housing 41. The gear structure 22 is rotatably disposed in the mounting hole 411, and the gear tooth 223 of the gear structure 22 is located outside the mounting hole 411, and can mesh with the rack structure 211. The functional component 40 is mounted on the wearing portion 10 by using the gear structure 22. After wearing the wearing portion 10, the user rotates the gear structure 22 to enable the gear structure 22 to move in the first direction relative to the rack structure 211. In this case, the gear structure 22 may drive, by using the housing 41, the functional component 40 to move in the first direction. It should be noted that the first direction may be generally understood as an up-and-down direction. Certainly, the first direction is not necessarily a completely vertical up-and-down direction. A person skilled in the art should understand that the front portion of the wearing portion 10 and the housing 41 may be disposed in an arc shape that can match the human head 50, the first direction is approximately a direction of moving up and down along the arc shape, and an overall moving position is moving up and down, which is not described in detail in this application.

According to an embodiment of this application, the adjustment component 20 further includes an adjustment rod 23, and the adjustment rod 23 is connected to the functional component 40, and the adjustment rod 23 is rotated or moved to enable the functional component 40 to move in a second direction.

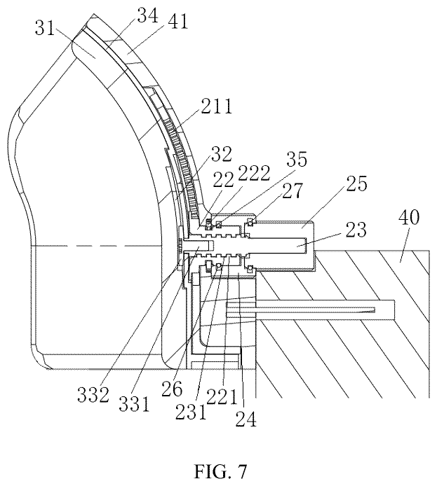

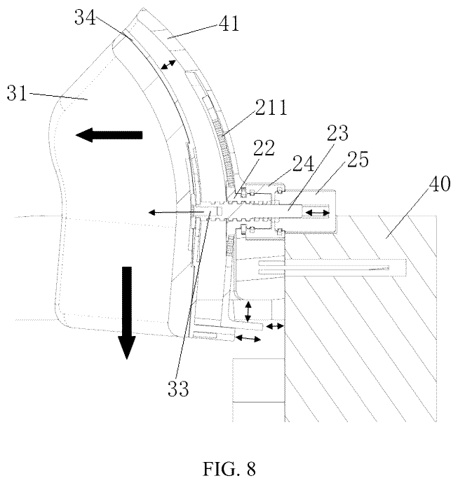

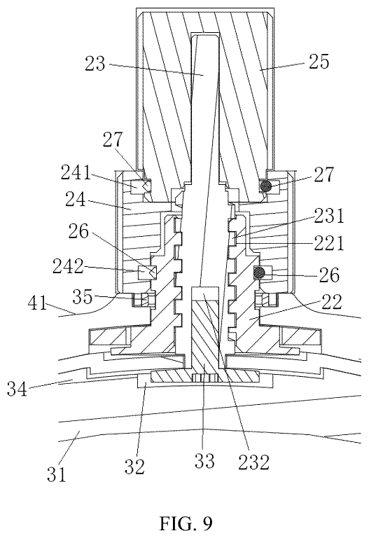

In other words, referring to FIG. 2, FIG. 7, and FIG. 9, the adjustment component may further include the adjustment rod 23. The adjustment rod 23 can be connected to the functional component 40. After wearing the wearing portion 10, the user may rotate or move the adjustment rod 23 to enable the functional component 40 to move in the second direction, where the second direction is different from the first direction, and the second direction may be understood as a length direction or a front-to-rear direction of the adjustment rod 23, thereby implementing front-to-rear adjustment of the functional component 40. In this application, by using the adjustment component 20, the functional component 40 can be adjusted in two different directions: the up-and-down direction and the front-to-rear direction (for a moving direction, refer to an arrow direction in FIG. 8), thereby further increasing a degree of freedom of a relative position of the glasses of the user relative to the screen of the functional component 40, and better meeting the use requirement of the user.

According to an embodiment of this application, the adjustment component 20 further includes an adjustment rod 23, the gear structure 22 has a through hole, the adjustment rod 23 penetrates the through hole, the gear structure 22 is rotatably sleeved on the adjustment rod 23, a first limiting structure 231 is disposed on an outer side of the adjustment rod 23, a second limiting structure 221 is disposed on an inner side of the through hole, and in a process in which the adjustment rod 23 rotates or moves in a second direction, the first limiting structure 231 is engaged with the second limiting structure 221 to drive the gear structure 22 to move in the second direction.

In other words, as shown in FIG. 2, FIG. 7, and FIG. 9, the adjustment component may further include the adjustment rod 23, the gear structure 22 has the through hole, and the adjustment rod 23 can penetrate the through hole, so that the gear structure 22 is rotatably sleeved on the adjustment rod 23. The first limiting structure 231 may be disposed on an outer side of the adjustment rod 23, and the second limiting structure 221 may be disposed on an inner side of the through hole. After the user wears the wearable device 100, the adjustment rod 23 abuts against a forehead through the front portion of the wearing portion 10. In this case, when the user rotates the adjustment rod 23, the adjustment rod 23 may rotate or move in the second direction. In this process, the first limiting structure 231 on the adjustment rod 23 is engaged with the second limiting structure 221 in the gear structure 22, to drive the gear structure 22 to move in the second direction, thereby adjusting a position of the functional component 40 in the second direction.

In this application, referring to FIG. 7 and FIG. 9, the first limiting structure 231 may be disposed as an external threaded structure on an outer peripheral surface of the adjustment rod 23, and the second limiting structure 221 may be disposed as an internal threaded structure that extends inside the through hole of the gear structure 22. The external threaded structure is engaged with the internal threaded structure. When the adjustment rod 23 rotates, because the wearable device 100 is worn on the human head, one end of the adjustment rod 23 is abutted by the head. In this case, the gear structure 22 and the adjustment rod 23 form a structure similar to a screw rod, so that the gear structure 22 moves in an axial direction of the adjustment rod 23, that is, moves in a length direction of the adjustment rod 23, to drive the functional component 40 to move in the axial direction of the adjustment rod 23, thereby implementing front-to-rear adjustment between the functional component 40 and a position of the human eye. It should be noted that the axial direction of the adjustment rod 23 is the second direction.

Certainly, the first limiting structure 231 may be alternatively disposed as a protrusion structure on the outer peripheral surface of the adjustment rod 23, and the second limiting structure may be alternatively disposed as a groove structure in the gear structure 22. Through engagement between the protrusion structure and the groove structure, movement of the gear structure 22 relative to the adjustment rod 23 can also be implemented, thereby adjusting front and rear positions of the functional component 40. In this application, specific structures of the first limiting structure 231 and the second limiting structure 221 are not limited, provided that a structural design that can implement relative movement between the gear structure 22 and the adjustment rod 23 falls within the protection scope of this application.

According to an embodiment of this application, the adjustment component 20 further includes a second knob 25, the second knob 25 is sleeved on the adjustment rod 23, the first limiting structure 231 is in threaded engagement with the second limiting structure 221, and the second knob 25 is rotated to drive the adjustment rod 23 to rotate, so as to drive the gear structure 22 to move in the second direction.

In other words, as shown in FIG. 7 to FIG. 9, the adjustment component 20 may further include the second knob 25, the second knob 25 may be sleeved on the adjustment rod 23, and the first limiting structure 231 and the second limiting structure 221 may be designed as a threaded engagement structure. After the user wears the wearing portion 10, because the wearable device 100 is worn on the human head, one end of the adjustment rod 23 is abutted by the head. In this case, the second knob 25 is rotated to drive the adjustment rod 23 to rotate, so as to drive the gear structure 22 to move in the second direction, thereby implementing forward and backward movement of the functional component 40.

In this application, a part that is of the adjustment rod 23 and that is corresponding to the second knob 25 may be designed as an incomplete circle, that is, this part of adjustment rod 23 may not be a complete cylindrical rod. With the design of the incomplete circle, it becomes easier to drive the adjustment rod 23 to rotate when the second knob 25 is rotated, thereby driving the gear structure 22 to move in the second direction.

According to an embodiment of this application, the adjustment component 20 further includes a first knob 24, the first knob 24 is disposed on an outer side of the gear structure 22, the first knob 24 is rotated to drive the gear structure 22 to rotate, and the gear structure 22 is engaged with the rack structure 211 to drive the functional component 40 to move in the first direction. The gear structure 22 is disposed at one end of the adjustment rod 23, and the second knob 25 is disposed at the other end of the adjustment rod 23. The second knob 25 and the first knob 24 are rotatably connected to each other, so as to restrict relative movement of the second knob 25 and the first knob 24 in the second direction.

In other words, referring to FIG. 2, FIG. 7, and FIG. 9, the adjustment component 20 may further include the first knob 24, and the first knob 24 may be disposed on the outer side of the gear structure 22. The first knob 24 is rotated to drive the gear structure 22 to rotate, and in addition, the gear structure 22 is engaged with the rack structure 211, to drive the functional component 40 to move in the first direction, thereby adjusting upper and lower positions of the functional component 40. The gear structure 22 is disposed at one end of the adjustment rod 23, and the second knob 25 is disposed at the other end of the adjustment rod 23. The second knob 25 and the first knob 24 are rotatably connected to each other, so as to restrict relative movement of the second knob 25 and the first knob 24 in the second direction. In this application, one adjustment rod 23 is disposed, and can cooperate with the first knob 24 and the second knob 25 to implement up-and-down and front-to-rear movement of the functional component 40, thereby effectively saving space and making operations easier.

After the user wears the wearing portion 10, referring to FIG. 7 and FIG. 9, when the position of the functional component 40 needs to be adjusted, the user may rotate the first knob 24, so that the first knob 24 drives the gear structure 22 to rotate relative to the rack structure 211 on the first bracket 21, thereby enabling the functional component 40 to move in the up-and-down direction. In addition, the second knob 25 may be rotated to drive the adjustment rod 23 to rotate. In this case, the gear structure 22 may move relative to the adjustment rod 23 in the length direction of the adjustment rod 23, thereby implementing coarse adjustment of the functional component 40 in the up-and-down direction and the front-to-rear direction. A coarse adjustment process mainly lies in adjusting the position of the functional component 40 in the up-and-down direction. After the coarse adjustment is completed, the second knob 25 may be rotated separately to drive the adjustment rod 23 to rotate, so that the gear structure 22 moves axially relative to the adjustment rod 23, thereby implementing fine adjustment of the functional component 40 in the front-to-rear direction, and ensuring that the wearable device 100 can meet the use requirement of the user.

In this application, to make it easier for the second knob 25 to drive the adjustment rod 23 to rotate, a limiting protrusion 413 or another limiting mechanism may be disposed on an outer peripheral surface of a part that is of the adjustment rod 23 and that is located on the second knob 25, and a limiting groove used to be engaged with the limiting protrusion 413 may be disposed within the second knob 25, so that when the user rotates the second knob 25, the second knob 25 drives the adjustment rod 23 to rotate, and therefore, the gear structure 22 drives the functional component 40 to move in the front-to-rear direction.

In some specific implementations of this application, the adjustment component 20 further includes a second snap ring 27, one end of the first knob 24 is provided with a first limiting recess, and an end portion of the second knob 25 extends into the first limiting recess. A first limiting groove 241 is disposed on a sidewall of the first limiting recess, and a second limiting groove 251 is disposed on the second knob 25. In a case that the end portion of the second knob 25 extends into the first limiting recess, the first limiting groove 241 and the second limiting groove 251 face each other to form a first limiting cavity, and the second snap ring 27 is disposed in the first limiting cavity to restrict relative movement of the second knob and the first knob 24 in the second direction.

In other words, referring to FIG. 2, FIG. 7, and FIG. 9, the adjustment component may further include the second snap ring 27, one end of the first knob 24 may be provided with the first limiting recess, and the end portion of the second knob 25 may extend into the first limiting recess. The first limiting groove 241 is disposed on the sidewall of the first limiting recess, and the second knob 25 is provided with the second limiting groove 251 corresponding to the first limiting groove 241. In a case that the end portion of the second knob 25 extends into the first limiting recess, the first limiting groove 241 and the second limiting groove 251 face each other to form the first limiting cavity, and the second snap ring 27 is disposed in the first limiting cavity, so that relative movement of the second knob 25 and the first knob 24 in the front-to-rear direction can be restricted by using the second snap ring 27, and it is convenient for the user to rotate the first knob 24 and the second knob 25 to perform adjustment in the up-and-down direction and the front-to-rear direction. In addition, the first knob 24 and the second knob 25 are connected to each other by using the second snap ring 27 for limiting, so that relative movement of the second knob 25 and the first knob 24 in the front-to-rear direction can be restricted while a better overall appearance of the wearable device 100 is ensured.

According to an embodiment of this application, the adjustment component 20 further includes a second bracket 31, the second bracket 31 is connected to the first bracket 21, and a first cavity 32 is formed between the first bracket 21 and the second bracket 31. The adjustment component 20 further includes a first limiting member 33, a guiding recess 232 is disposed on an end surface of the adjustment rod 23, one end of the first limiting member 33 is located in the first cavity 32, and the other end of the first limiting member 33 is movably inserted into the guiding recess 232 of the adjustment rod 23. When the adjustment rod 23 is rotated, the first limiting member 33 restricts movement of the adjustment rod 23 in the second direction, so that the gear structure 22 moves in the second direction.

In other words, referring to FIG. 2, FIG. 7, and FIG. 9, the adjustment component may further include the second bracket 31, the second bracket 31 is connected to the first bracket 21, and when the wearable device 100 is worn, the second bracket 31 can fit into a forehead position. The first cavity 32 is formed between the first bracket 21 and the second bracket 31. The adjustment component 20 may further include the first limiting member 33, and the guiding recess 232 may be disposed on an end surface of the adjustment rod 23 that faces the second bracket 31. One end of the first limiting member 33 is located in the first cavity 32, and the other end of the first limiting member 33 is movably inserted into the guiding recess 232 of the adjustment rod 23. After the user wears the wearing portion 10, the user may rotate the adjustment rod 23, so that the adjustment rod 23 abuts against the forehead by using the first limiting member 33 and the second bracket 31. In this case, the first limiting member 33 restricts movement of the adjustment rod 23 in the second direction, so that the gear structure 22 moves in the second direction, thereby driving the functional component 40 to move in the second direction (the front-to-rear direction), and adjusting a front position and a rear position of the functional component 40.

In this application, as shown in FIG. 2, FIG. 7, and FIG. 9, the adjustment component 20 may further include a third bracket 34, the third bracket 34 is disposed between the first bracket 21 and the second bracket 31, and the third bracket 34 is connected to the first bracket 21. The second bracket 31 may be connected to the first bracket 21 by using the third bracket 34. A guiding through-hole 341 may be disposed on a part that is of the third bracket 34 and that is located in the first cavity 32. The guiding through-hole 341 is in communication with the first cavity 32 and extends in the first direction.

Referring to FIG. 7 and FIG. 9, the adjustment component 20 may further include a first limiting member 33. The first limiting member 33 includes a first guiding portion 331 and a first flange portion 332 that are connected to each other. One end of the first guiding portion 331 that is away from the first flange portion 332 extends into the guiding recess 232 through the guiding through-hole 341. The first limiting member 33 may be connected to the gear structure 22 by using the adjustment rod 23, and moves in the first direction with the gear structure 22. The first flange portion 332 is sandwiched between the third bracket 34 and the second bracket 31, and the gear structure 22 is limited between the third bracket 34 and the first bracket 21.

As shown in FIG. 9, in a process in which the gear structure 22 rotates, the first limiting member 33 moves along the guiding through-hole 341, that is, the first limiting member 33 moves in the first direction with the gear structure 22, and the first guiding portion 331 may move along the guiding recess 232. Specifically, because the second bracket 31 is designed as an arc surface that matches the forehead of the user, in a process in which the gear structure 22 drives the functional component 40 to move in the first direction, the first limiting member 33 and the adjustment rod 23 may move relative to each other in the second direction to avoid being stuck.

In a process in which the adjustment rod 23 rotates, the first limiting member 33 restricts movement of the adjustment rod 23 in the second direction, so that the gear structure 22 moves in the second direction.

In some specific implementations of this application, referring to FIG. 2, FIG. 7, and FIG. 9, the adjustment component 20 further includes a first knob 24, one end of the first knob 24 is provided with a second limiting recess, one end of the gear structure 22 is inserted into the second limiting recess, and the other end of the gear structure 22 is provided with a gear tooth 223. The adjustment component 20 further includes a first snap ring 26. A third limiting groove 242 is disposed on a sidewall of the second limiting recess, and one end of the gear structure 22 is provided with a fourth limiting groove 222. In a case that one end of the gear structure 22 extends into the second limiting recess, the third limiting groove 242 and the fourth limiting groove 222 face each other to form a second limiting cavity. The second snap ring 27 is disposed in the second limiting cavity, to restrict relative movement of the gear structure 22 and the first knob 24 in the second direction. The first knob 24 is rotated to drive the gear structure 22 to rotate, and the gear tooth 223 meshes with the rack structure 211, so that the gear structure 22 moves in the first direction, thereby driving the functional component 40 to move in the first direction.

In other words, referring to FIG. 2, FIG. 7, and FIG. 9, the adjustment component may further include the first knob 24, one end of the first knob 24 may be provided with the second limiting recess, and one end of the gear structure 22 is inserted into the second limiting recess of the first knob 24. The gear tooth 223 is disposed on an outer side of the other end of the gear structure 22, and the gear tooth 223 meshes with the rack structure 211 on the first bracket 21. The adjustment component 20 further includes the first snap ring 26, the third limiting groove 242 may be disposed on the sidewall of the second limiting recess, and one end of the gear structure 22 is provided with the fourth limiting groove 222. In a case that one end of the gear structure 22 extends into the second limiting recess, the third limiting groove 242 and the fourth limiting groove 222 face each other to form the second limiting cavity. The second snap ring 27 is mounted in the second limiting cavity, and relative movement of the gear structure 22 and the first knob 24 in an axial direction of the adjustment rod 23 may be restricted by using the second snap ring 27. After the user wears the wearing portion 10, the first knob 24 may be rotated to drive the gear structure 22 to rotate, and the gear teeth 223 meshes with the rack structure 211, so that the gear structure 22 moves in the first direction along the rack structure 211, to drive the functional component 40 to move in the first direction, thereby adjusting the position of the functional component 40 in the up-and-down direction.

According to an embodiment of this application, the adjustment component 20 further includes a first knob 24 and a self-locking component 35, and the self-locking component 35 is disposed between the first knob 24 and the housing 41 to restrict rotation of the gear structure 22. An accommodating recess 412 is disposed on a side of the housing 41 that faces the first knob 24, and a plurality of limiting protrusions 413 are disposed on a sidewall of the accommodating recess 412. The mounting hole 411 is disposed on a bottom surface of the accommodating recess 412. One end of the gear structure 22 is connected to the first knob 24 through the mounting hole 411, and the first knob 24 is sleeved on an outer side of the gear structure 22.

The self-locking component 35 includes a self-locking limiting member 351, the self-locking limiting member 351 is sleeved on the outer side of the gear structure 22, the self-locking limiting member 351 is disposed in the accommodating recess 412, and the self-locking limiting member 351 has a connection portion 3551 and at least one self-locking limiting portion. The connection portion 3551 is connected to the gear structure 22 to restrict relative rotation between the self-locking limiting member 351 and the gear structure 22. In a case that the self-locking component 35 is in a self-locked state, the self-locking limiting portion abuts against the limiting protrusion 413 to restrict rotation of the self-locking limiting member 351 relative to the housing 41.

A toggling portion is disposed on a side of the first knob 24 that faces the housing 41, the toggling portion is sandwiched between the self-locking limiting member 351 and a sidewall of the accommodating recess 412, and when the first knob 24 is rotated, the toggling portion rotates in a rotation direction of the first knob 24, to push the self-locking limiting portion to move relative to the limiting protrusion 413, so that the adjustment component 20 switches from the self-locked state to an adjustment state.

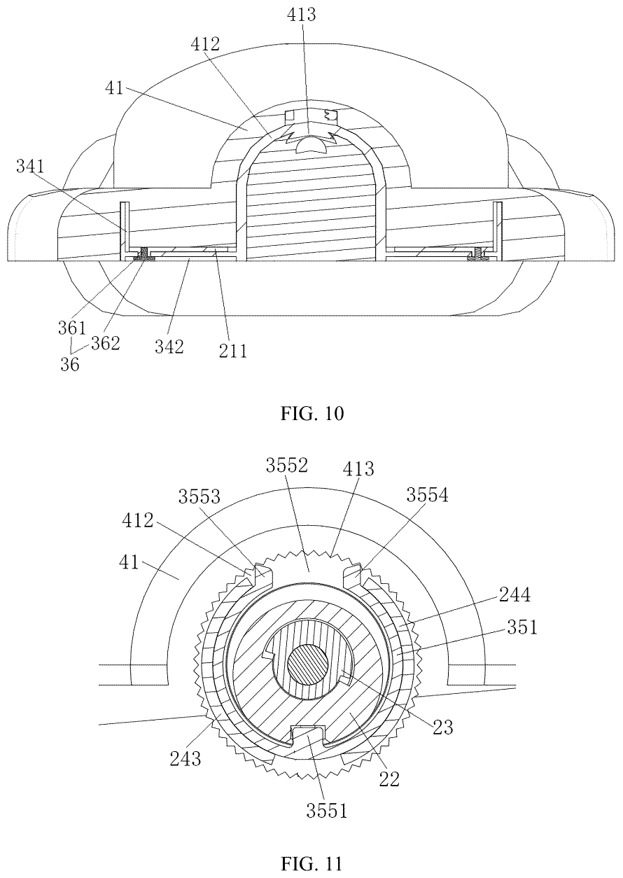

In other words, as shown in FIG. 7, the adjustment component 20 may further include the first knob 24 and the self-locking component 35, the self-locking component 35 is disposed between the first knob 24 and the housing 41, and the self-locking component 35 is mainly configured to restrict rotation of the gear structure 22, so that the gear structure 22 and the adjustment rod 23 form a structure similar to a screw rod. Referring to FIG. 10 to FIG. 12, the accommodating recess 412 is disposed on the side of the housing 41 that faces the first knob 24, the plurality of limiting protrusions 413 are disposed on the sidewall of the accommodating recess 412, and the plurality of limiting protrusions 413 are arranged in an annular shape in the accommodating recess 412. The mounting hole 411 in the housing 41 is disposed on the bottom surface of the accommodating recess 412, one end of the gear structure 22 may be connected to the first knob 24 through the mounting hole 411, and the first knob 24 is sleeved on the outer side of the gear structure 22, so that the first knob 24 drives the gear structure 22 to rotate.

As shown in FIG. 11, the self-locking component 35 includes the self-locking limiting member 351, the self-locking limiting member 351 is sleeved on the outer side of the gear structure 22, the self-locking limiting member 351 is disposed in the accommodating recess 412, and the self-locking limiting member 351 has the connection portion 3551 and the at least one self-locking limiting portion. The connection portion 3551 is connected to the gear structure 22. The connection portion 3551 may restrict relative rotation between the self-locking limiting member 351 and the gear structure 22. In a case that the self-locking component 35 is in the self-locked state, the self-locking limiting portion abuts against the limiting protrusion 413 to restrict rotation of the self-locking limiting member 351 relative to the housing 41. In this case, the second knob 25 is rotated to drive the adjustment rod 23 to rotate. Because the self-locking component 35 self-locks the gear structure 22, the gear structure 22 cannot rotate, and the gear structure 22 moves in a length direction of the adjustment rod 23, thereby driving the functional component 40 to move forward and backward.

The toggling portion is disposed on the side of the first knob 24 that faces the housing 41, and the toggling portion may be sandwiched between the self-locking limiting member 351 and the sidewall of the accommodating recess 412. After wearing the wearing portion 10, the user rotates the first knob 24 to enable the toggling portion to rotate in the rotation direction of the first knob 24, to push the self-locking limiting portion and the limiting protrusion 413 to move relative to each other, so that the adjustment component 20 switches from the self-locked state to the adjustment state, thereby ensuring that the gear structure 22 can rotate relative to the rack structure 211 on the first bracket 21, and implementing up-and-down adjustment of the functional component 40.

It should be noted that in this application, a case that the wearing portion 10 is worn on the user head is mainly used as an example for description. After the wearing portion 10 is worn on the head, because the second bracket 31 abuts against the forehead position of the head, the adjustment rod 23 abuts against the forehead position by using the first limiting member 33 and the second bracket 31. Therefore, when the second knob 25 is rotated, a front-to-rear moving position of the adjustment rod 23 is restricted, so that the gear structure 22 moves forward and backward relative to the adjustment rod 23, thereby implementing front-to-rear adjustment of the functional component 40.

When the wearing portion 10 is not worn on the human head 50, the second knob is rotated to enable the adjustment rod 23 to move in the second direction relative to the gear structure 22 (refer to FIG. 8), and a distance between the second bracket 31 and the functional component 40 in the second direction may be adjusted, so that a size of the wearing space 11 can be adjusted to make it convenient for the wearable device 100 to adapt to users of different head sizes, thereby improving flexibility and universality of adjustment of the wearable device 100.

In some specific implementations of this application, the self-locking limiting member 351 may be deformed, and a deformation gap is reserved between the self-locking limiting member and the gear structure 22. In a case that the adjustment component 20 is in the self-locked state, the self-locking limiting portion abuts against the limiting protrusion 413 to restrict rotation of the gear structure 22 by using the connection portion 3551, thereby restricting movement of the gear structure 22 in the first direction relative to the rack structure 211, and further restricting movement of the functional component 40 in the first direction.

In a case that the first knob 24 is rotated to enable the adjustment component 20 to be in the adjustment state, the first knob 24 drives the gear structure 22 and the self-locking limiting member 351 to rotate, and the toggling portion rotates with the first knob 24 and presses the self-locking limiting member 351 to be deformed, to enable the self-locking limiting portion to move relative to the limiting protrusion 413.

In other words, referring to FIG. 11, the self-locking limiting member 351 may be deformed in a working process, and the deformation gap is reserved between the self-locking limiting portion of the self-locking limiting member 351 and the gear structure 22, so that the self-locking limiting portion is deformed, to switch between the self-locked state and an unlocked state. After the user wears the wearing portion 10, in a case that the adjustment component 20 is in the self-locked state, the self-locking limiting portion abuts against the limiting protrusion 413. In this case, rotation of the gear structure 22 can be restricted by the connection portion 3551, so that movement of the gear structure 22 in the first direction relative to the rack structure 211 can be restricted, and further, movement of the functional component in the first direction can be restricted. In a case that the first knob 24 is rotated to enable the adjustment component 20 to be in the adjustment state, the first knob 24 can drive the gear structure 22 and the self-locking limiting member 351 to rotate. In this case, the toggling portion can rotate with the first knob 24 and press the self-locking limiting member 351 to be deformed, so that the self-locking limiting portion can move relative to the limiting protrusion 413, thereby implementing movement of the gear structure 22 in the first direction relative to the rack structure 211.

According to an embodiment of this application, the self-locking limiting member 351 is an annular member with a notch 3552, the self-locking limiting member 351 is provided with a first self-locking limiting portion 3553 and a second self-locking limiting portion 3554, and the notch 3552 is formed between the first self-locking limiting portion 3553 and the second self-locking limiting portion 3554. In a case that the adjustment component 20 is in the self-locked state, the first self-locking limiting portion 3553 and the second self-locking limiting portion 3554 each abut against one limiting protrusion 413 for limiting, the first self-locking limiting portion 3553 restricts rotation of the gear structure 22 in a clockwise direction, and the second self-locking limiting portion 3554 restricts rotation of the gear structure 22 in a counter-clockwise direction. The first knob 24 has a first toggling portion 243 and a second toggling portion 244, the first toggling portion 243 is disposed on a side of the first self-locking limiting portion 3553 that is away from the notch 3552, and the first toggling portion 243 is configured to release abutment limiting between the first self-locking limiting member portion and one limiting protrusion 413 in a case that the first knob 24 is rotated. The second toggling portion 244 is disposed on a side of the second self-locking limiting portion 3554 that is away from the notch 3552, and the second toggling portion 244 is configured to release abutment limiting between the second self-locking limiting portion 3554 and another limiting protrusion 413 in a case that the first knob 24 is rotated.

In other words, as shown in FIG. 11, the self-locking limiting member 351 may be designed as the annular member with the notch 3552. The self-locking limiting member 351 is provided with the first self-locking limiting portion 3553 and the second self-locking limiting portion 3554, and the notch 3552 may be disposed between the first self-locking limiting portion 3553 and the second self-locking limiting portion 3554. In a case that the adjustment component 20 is in the self-locked state, the first self-locking limiting portion 3553 and the second self-locking limiting portion 3554 each abut against one limiting protrusion 413 for limiting. The first self-locking limiting portion 3553 may restrict rotation of the gear structure 22 in the clockwise direction, and the second self-locking limiting portion 3554 may restrict rotation of the gear structure 22 in the counterclockwise direction, thereby ensuring that the gear structure 22 can be self-locked.

Referring to FIG. 11, the first knob 24 has the first toggling portion 243 and the second toggling portion 244, and the first toggling portion 243 may be disposed on the side of the first self-locking limiting portion 3553 that is away from the notch 3552. The first toggling portion 243 is mainly configured to release abutment limiting between the first self-locking limiting portion 3553 and one limiting protrusion 413 in a case that the first knob 24 is rotated. The second toggling portion 244 may be disposed on the side of the second self-locking limiting portion 3554 that is away from the notch 3552, and the second toggling portion 244 is mainly configured to release abutment limiting between the second self-locking limiting portion 3554 and another limiting protrusion 413 in a case that the first knob 24 is rotated, so as to ensure that the gear structure 22 can move relative to the rack structure 211, thereby implementing movement of the functional component 40 in the first direction.

In some specific implementations of this application, as shown in FIG. 2 and FIG. 7, the adjustment component 20 may further include a second bracket 31 and a third bracket 34, the third bracket 34 may be disposed between the first bracket 21 and the second bracket 31, and the third bracket 34 is connected to the first bracket 21. The second bracket 31 may be connected to the first bracket 21 by using the third bracket 34, and a first cavity 32 is formed between the first bracket 21 and the second bracket 31. A guiding through-hole 341 is disposed on a part that is of the third bracket 34 and that is located in the first cavity 32, and the guiding through-hole 341 is in communication with the first cavity 32 and extends in the first direction.

As shown in FIG. 2 and FIG. 7, the adjustment component 20 may further include a first limiting member 33. The first limiting member 33 includes a first guiding portion 331 and a first flange portion 332 that are connected to each other. One end of the first guiding portion 331 that is away from the first flange portion 332 can pass through the guiding through-hole 341 and be connected to the gear structure 22. The first flange portion 332 is sandwiched between the third bracket 34 and the second bracket 31, so as to limit a position of the adjustment rod 23. After the wearing portion 10 is worn, the gear structure 22 moves in the second direction relative to the adjustment rod 23. In a process in which the gear structure 22 moves in the first direction relative to the rack structure 211, the first limiting member 33 moves along the guiding through-hole 341.

In a process in which the gear structure 22 rotates, the first limiting member 33 moves along the guiding through-hole 341, that is, the first limiting member 33 moves with the gear structure 22 in the first direction, and the first guiding portion 331 may move along the guiding recess 232. Specifically, because the second bracket 31 is designed as an arc surface that matches the forehead of the user, in a process in which the gear structure 22 drives the functional component 40 to move in the first direction, the first limiting member 33 and the adjustment rod 23 may move relative to each other in the second direction to avoid being stuck. In a process in which the adjustment rod 23 rotates, the first limiting member 33 restricts movement of the adjustment rod 23 in the second direction, so that the gear structure 22 moves in the second direction.

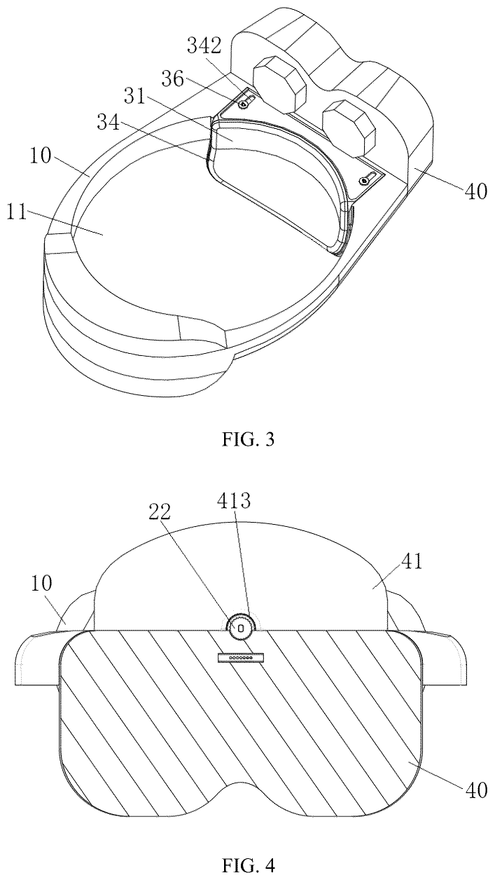

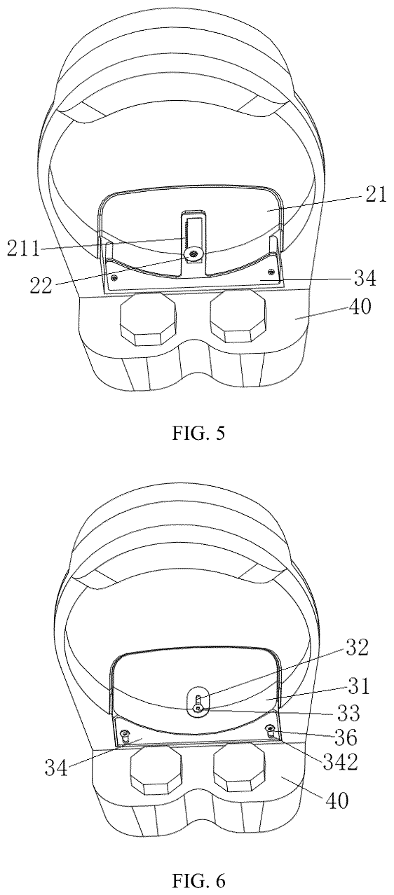

According to an embodiment of this application, as shown in FIG. 2, FIG. 3, and FIG. 6, a sliding slot 342 may be disposed on the third bracket 34, and the sliding slot 342 may extend in the second direction. The adjustment component 20 may further include a second limiting member 36, and the third bracket 34 may be connected to the first bracket 21 through the second limiting member 36. In a process in which the adjustment rod 23 rotates, referring to FIG. 4, FIG. 5, and FIG. 7, the gear structure 22 can drive the first bracket 21 to move in the second direction, and the second limiting member 36 moves along the sliding slot 342, so that the functional component 40 moves in the second direction.

Optionally, referring to FIG. 10, the second limiting member 36 includes a second guiding portion 361 and a second flange portion 362 that are connected to each other, and one end of the second guiding portion 361 that is away from the second flange portion 362 can be connected to the first bracket 21 through the sliding slot 342, thereby connecting the first bracket 21 and the third bracket 34. The second flange portion 362 is located outside the sliding slot 342, so that relative movement of the first bracket 21 and the third bracket 34 in the first direction can be restricted, thereby ensuring movement of the first bracket 21 and the third bracket 34 in the second direction.

According to an embodiment of this application, as shown in FIG. 13, the functional component 40 includes a display member configured to face an eye of the user. A range of an included angle between the first direction and a connection line between both eyes of the user is approximately from 75 degrees to 110°, and the second direction is perpendicular to the first direction, so that the wearable device 100 designs specific moving ranges of the functional component 40 in the first direction and the second direction based on an actual wearing situation.

In a general case, the range of the included angle between the first direction and the connection line between both eyes of the user is approximately 90 degrees, so that adjustment of the functional component 40 in the up-to-down direction is completed by using a shortest path, adjustment efficiency can be maximized when the user performs coarse adjustment and fine adjustment on a position of the functional component 40, and operation time can be reduced.

In the wearable device 100 in this embodiment, the position of the functional component 40 in the first direction and the second direction may be adjusted by using the adjustment component 20, to ensure that a screen center of the display member of the functional component 40 can be consistent with a pupil center of the eye of the user by adjusting up and down in the first direction after the wearable device is worn, and ensure that the display member of the functional component 40 can adjust a spacing between the screen and the eye of the user by adjusting back and forth in the second direction, thereby improving comfort of the user during wearing. In addition, in a process in which the display member of the functional component 40 is adjusted up and down in the first direction, through an arc surface design in which the first bracket 21 in the adjustment component is fitted to the forehead of the human, the user can freely adjust a wearing inclination, force uniformity, and the like, thereby further improving use experience of the user.

It should be noted that in this application, the up-and-down direction, that is, the first direction, refers to a direction in which the head points to the foot or the foot points to the head when the user is standing after wearing the wearable device. The front-to-rear direction, that is, the second direction, refers to a direction in which the back points to the chest or the chest points to the back when the user is standing after wearing the wearable device.

Certainly, for a person skilled in the art, another structure and a working principle of the wearable device 100 may be understood and implemented, and details are not described in this application.

In this embodiment of this application, the adjustment component is disposed on the wearing portion, and the functional component is connected to the gear structure by using the first bracket and the gear structure in the adjustment component. Through rotation of the gear structure, the gear structure is driven to move in the first direction relative to the rack structure in the first bracket, so that the functional component moves in the first direction, to adjust a position of the functional component and a position of glasses of a user, and meet a use requirement of the user. In this application, the position of the functional component is adjusted by rotating the gear structure, so that a structure is simple, use is facilitated, a degree of freedom is high, and it is convenient for the user to perform free adjustment based on a requirement.

In the descriptions of this specification, the description with reference to the terms such as “an embodiment”, “some embodiments”, “an illustrative embodiment”, “an example”, “a specific example”, or “some examples” means that a specific feature, a structure, a material, or a characteristic described with reference to the embodiment or example is included in at least one embodiment or example of this application. In this specification, the foregoing example expressions of the terms are not necessarily with respect to a same embodiment or example. In addition, the described specific features, structures, materials, or characteristics may be combined in a proper manner in any one or more of embodiments or examples.

Although the embodiments of this application have been illustrated and described, a person of ordinary skill in the art can understand that various changes, modifications, replacements, and variants may be made to these embodiments without departing from the principle and purpose of this application, and the scope of this application is limited by the claims and their equivalents.

1. A wearable device, comprising:
a wearing portion, wherein the wearing portion has wearing space;
an adjustment component connected to the wearing portion, wherein the adjustment component comprises a first bracket and a gear structure, the first bracket has a rack structure, the rack structure extends in a first direction, and the gear structure meshes with the rack structure; and
a functional component, wherein the functional component is connected to the gear structure, and rotation of the gear structure causes the gear structure to move in the first direction relative to the rack structure, so that the functional component is driven to move in the first direction.

2. The wearable device according to claim 1, wherein the functional component has a housing, the first bracket is located between the wearing portion and the housing, a mounting hole is disposed on one side of the housing, the gear structure is rotatably disposed in the mounting hole, and a gear tooth of the gear structure is located outside the mounting hole to mesh with the rack structure; and
in a case that the gear structure moves in the first direction relative to the rack structure, the gear structure drives, by using the housing, the functional component to move in the first direction.

3. The wearable device according to claim 1, wherein the adjustment component further comprises an adjustment rod, the adjustment rod is connected to the functional component, and the adjustment rod is rotated or moved to enable the functional component to move in a second direction, wherein the first direction is different from the second direction.

4. The wearable device according to claim 1, wherein the adjustment component further comprises an adjustment rod, the gear structure has a through hole, the adjustment rod penetrates the through hole, the gear structure is rotatably sleeved on the adjustment rod, a first limiting structure is disposed on an outer side of the adjustment rod, a second limiting structure is disposed on an inner side of the through hole, and in a process in which the adjustment rod rotates or moves in a second direction, the first limiting structure is engaged with the second limiting structure to drive the gear structure to move in the second direction, and the adjustment rod extends in the second direction, wherein the first direction is different from the second direction.

5. The wearable device according to claim 4, wherein the adjustment component further comprises a second knob, the second knob is sleeved on the adjustment rod, the first limiting structure is in threaded engagement with the second limiting structure, and the second knob is rotated to drive the adjustment rod to rotate, so as to drive the gear structure to move in the second direction.

6. The wearable device according to claim 5, wherein the adjustment component further comprises a first knob, the first knob is disposed on an outer side of the gear structure, the first knob is rotated to drive the gear structure to rotate, and the gear structure is engaged with the rack structure to drive the functional component to move in the first direction; the gear structure is disposed at one end of the adjustment rod, and the second knob is disposed at the other end of the adjustment rod; and the second knob and the first knob are rotatably connected to each other, to restrict relative movement of the second knob and the first knob in the second direction.

7. The wearable device according to claim 6, wherein the adjustment component further comprises a second snap ring, one end of the first knob is provided with a first limiting recess, and an end portion of the second knob extends into the first limiting recess; a first limiting groove is disposed on a sidewall of the first limiting recess, and a second limiting groove is disposed on the second knob; and in a case that the end portion of the second knob extends into the first limiting recess, the first limiting groove and the second limiting groove face each other to form a first limiting cavity, and the second snap ring is disposed in the first limiting cavity to restrict relative movement of the second knob and the first knob in the second direction.

8. The wearable device according to claim 4, wherein the adjustment component further comprises a second bracket, the second bracket is connected to the first bracket, and a first cavity is formed between the first bracket and the second bracket;
the adjustment component further comprises a first limiting member, a guiding recess is disposed on an end surface of the adjustment rod, one end of the first limiting member is located in the first cavity, and the other end of the first limiting member is movably inserted into the guiding recess of the adjustment rod; and
when the adjustment rod is rotated, the first limiting member restricts movement of the adjustment rod in the second direction, so that the gear structure moves in the second direction.

9. The wearable device according to claim 2, wherein the adjustment component further comprises a first knob and a self-locking component, and the self-locking component is disposed between the first knob and the housing to limit rotation of the gear structure;
an accommodating recess is disposed on a side of the housing that faces the first knob, a plurality of limiting protrusions are disposed on a sidewall of the accommodating recess, the mounting hole is disposed on a bottom surface of the accommodating recess, one end of the gear structure is connected to the first knob through the mounting hole, and the first knob is sleeved on an outer side of the gear structure;
the self-locking component comprises a self-locking limiting member, the self-locking limiting member is disposed on the outer side of the gear structure, the self-locking limiting member is disposed in the accommodating recess, the self-locking limiting member has a connection portion and at least one self-locking limiting portion, and the connection portion is connected to the gear structure to restrict relative rotation between the self-locking limiting member and the gear structure; and in a case that the self-locking component is in a self-locked state, the self-locking limiting portion abuts against the limiting protrusion to restrict rotation of the self-locking limiting member relative to the housing; and
a toggling portion is disposed on a side of the first knob that faces the housing, the toggling portion is sandwiched between the self-locking limiting member and the sidewall of the accommodating recess, and when the first knob is rotated, the toggling portion rotates in a rotation direction of the first knob, to push the self-locking limiting portion to move relative to the limiting protrusion, so that the adjustment component switches from the self-locked state to an adjustment state.

10. The wearable device according to claim 9, wherein the self-locking limiting member is deformable, and a deformation gap is reserved between the self-locking limiting portion and the gear structure;
in a case that the adjustment component is in the self-locked state, the connection portion restricts rotation of the gear structure, to restrict movement of the gear structure in the first direction relative to the rack structure; and
in a case that the first knob is rotated to enable the adjustment component to be in the adjustment state, the first knob drives the gear structure and the self-locking limiting member to rotate, and the toggling portion rotates with the first knob and presses the self-locking limiting member to be deformed, to enable the self-locking limiting portion to move relative to the limiting protrusion.

11. The wearable device according to claim 9, wherein the self-locking limiting member is an annular member with a notch, the self-locking limiting member is provided with a first self-locking limiting portion and a second self-locking limiting portion, and the notch is formed between the first self-locking limiting portion and the second self-locking limiting portion;
in a case that the adjustment component is in the self-locked state, the first self-locking limiting portion and the second self-locking limiting portion each abut against one limiting protrusion for limiting, the first self-locking limiting portion restricts rotation of the gear structure in a clockwise direction, and the second self-locking limiting portion restricts rotation of the gear structure in a counterclockwise direction; and
the first knob has a first toggling portion and a second toggling portion, the first toggling portion is disposed on a side of the first self-locking limiting portion that is away from the notch, and the first toggling portion is configured to release abutting limiting between the first self-locking limiting portion and one limiting protrusion in a case that the first knob is rotated; and
the second toggling portion is disposed on a side of the second self-locking limiting portion that is away from the notch, and the second toggling portion is configured to release abutment limiting between the second self-locking limiting portion and another limiting protrusion in a case that the first knob is rotated.

12. The wearable device according to claim 3, wherein the adjustment component further comprises a second bracket and a third bracket, the third bracket is disposed between the first bracket and the second bracket, the third bracket is connected to the first bracket, the second bracket is connected to the first bracket by using the third bracket, a first cavity is formed between the first bracket and the second bracket, a guiding through-hole is disposed on a part that is of the third bracket and that is located in the first cavity, and the guiding through-hole is in communication with the first cavity and extends in the first direction;
the adjustment component further comprises a first limiting member, the first limiting member comprises a first guiding portion and a first flange portion that are connected to each other, one end of the first guiding portion that is away from the first flange portion passes through the guiding through-hole and is connected to the gear structure, and the first flange portion is sandwiched between the third bracket and the second bracket; and
in a process in which the gear structure moves in the first direction relative to the rack structure, the first limiting member moves along the guiding through-hole.

13. The wearable device according to claim 12, wherein a sliding slot is disposed on the third bracket, and the sliding slot extends in the second direction; and
the adjustment component further comprises a second limiting member, the third bracket is connected to the first bracket through the second limiting member, and in a process in which the adjustment rod rotates, the gear structure drives the first bracket to move in the second direction, the second limiting member moves along the sliding slot, and the first direction is different from the second direction.

14. The wearable device according to claim 13, wherein the second limiting member comprises a second guiding portion and a second flange portion that are connected to each other, one end of the second guiding portion that is away from the second flange portion is connected to the first bracket through the sliding groove, and the second flange portion is located outside the sliding groove to restrict relative movement of the first bracket and the third bracket in the first direction.

15. The wearable device according to claim 1, wherein the functional component comprises a display member configured to face an eye of a user, a range of an included angle between the first direction and a connecting line between both eyes of the user is from 75 degrees to 110°, and the second direction is perpendicular to the first direction.

16. The wearable device according to claim 2, wherein the functional component comprises a display member configured to face an eye of a user, a range of an included angle between the first direction and a connecting line between both eyes of the user is from 75 degrees to 110°, and the second direction is perpendicular to the first direction.

17. The wearable device according to claim 3, wherein the functional component comprises a display member configured to face an eye of a user, a range of an included angle between the first direction and a connecting line between both eyes of the user is from 75 degrees to 110°, and the second direction is perpendicular to the first direction.

18. The wearable device according to claim 4, wherein the functional component comprises a display member configured to face an eye of a user, a range of an included angle between the first direction and a connecting line between both eyes of the user is from 75 degrees to 110°, and the second direction is perpendicular to the first direction.

19. The wearable device according to claim 5, wherein the functional component comprises a display member configured to face an eye of a user, a range of an included angle between the first direction and a connecting line between both eyes of the user is from 75 degrees to 110°, and the second direction is perpendicular to the first direction.

20. The wearable device according to claim 6, wherein the functional component comprises a display member configured to face an eye of a user, a range of an included angle between the first direction and a connecting line between both eyes of the user is from 75 degrees to 110°, and the second direction is perpendicular to the first direction.
